(19) United States
(12) Patent Application Publication
(10) Pub. No.: US 2006/0209782 A1
(43) Pub. Date: Sep. 21, 2006

(54) BANDWIDTH OPTIMIZATION SYSTEM

(76) Inventors: Charles Miller, Longmont, CO (US); Bernard Vachon, .., CO (US); Mathew Nieberger, Longmont, CO (US)

Correspondence Address: HOLLAND & HART, LLP, P.O BOX 8749, DENVER, CO, 80201, US

(21) Appl. No.: 10/905,984

(22) Filed: Jan. 28, 2005

(51) Int. Cl. H04J 3/24

(52) U.S. Cl. 370/349

(57) ABSTRACT

An interface between the BTS and BSC optimizes data transmitted over, for example, T1 lines to effectively increase the transmission bandwidth. The method comprises determined whether a frame of data is available for optimization. If available, the frame type is identified, the payload is extracted, and a header compiled. The payload and header are used to generate the optimized frame of data. The data stream is aggregated with non-optimized frames of data and transmitted.

### FIELD OF THE INVENTION

The present invention relates to data communication systems and, more particularly, to a system that allows reduction of data that must be transferred over a communication link that in turn optimizes the bandwidth use.

1. Background of the Invention

Communication networks, and particularly wireless communication networks, operate by sending information between Base Transceiver Stations (“BTS”) and Base Station Controllers (“BSC). FIG. 1 shows a typical wireless communication network 100. Wireless communication network 100 relates to cellular telephone or mobile stations 102₁, 102₂ to 102ₙ, but other data communication devices could be substituted for mobile stations 102. Mobile stations 102 establish wireless communication links 104 to BTS 106. Conventionally, BTS 106 is connected to BSC 108 using wired communication links 110, such as, for example, T-1 lines, T-3 lines, T-4 lines, the E line equivalents, or the like.

In operation, mobile stations 102₁₋ₙ transmit corresponding data 112₁₋ₙ to BTS 106. BTS 106 packages each data 112 pursuant to a transmission protocol and transmits the each data 112 to BSC 108 using conventional protocols. Conventionally, BTS 106 organizes, for example data 112₂ into a frame 114₂ of data. In other words, for each data 112₁₋ₙ there is a corresponding frame 114₁₋ₙ. The frame is transmitted with a plurality of other data to BSC 108. The plurality of other data can be additional frames of data, EDGE data, signaling data, or the like. Because the entire transmission is transmitted using a predefined protocol, BSC 108 can extract the frame corresponding to data 112₂ and distribute the data as required to local or remote endpoints (not specifically shown but generally known in the art).

While the above system works satisfactorily, wireless communication is currently on the increase. Each communication link 110, however, has a limited amount of bandwidth to transmit data from BTS 106 to BSC 108. Installing additional communication links 110 presents an unsatisfactory solution because it is an expensive and limited solution to the need for additional bandwidth between BTS 106 and BSC 108.

An alternative solution to increasing the number of communication links 110 would be to reduce the amount of data transmitted for each mobile station 102 between BTS 106 and BSC 108. Reducing the amount of data transmitted increases the usable bandwidth and, therefore, additional mobile station traffic could be supported by each communication link 110.

2. Summary of the Invention

To attain the advantages and in accordance with the present invention, a method to optimized bandwidth between a base transceiver station and a base station controller are provided. The method comprises the steps of receiving a plurality of frames of data for transmission over a communication link between the BTS and BSC. For each frame, it is determined whether the frame is available for optimization. If available, the frame type is identified, the payload is extracted, and a header compiled. The payload and header are used to generate the optimized frame of data. The data stream is aggregated with non-optimized frames of data and transmitted.

The foregoing and other features, utilities and advantages of the invention will be apparent from the following more particular description of a preferred embodiment of the invention as illustrated in the accompanying drawings.

### BRIEF DESCRIPTION OF THE DRAWING

The accompanying drawings, which are incorporated in and constitute a part of this specification, illustrate some preferred embodiments of the invention and, together with the description, explain the goals, advantages and principles of the invention. In the drawings,

FIG. 1 is a functional block diagram illustrating a conventional mobile communication system;

FIG. 2 is a functional block diagram illustrating a communication system consistent with an embodiment of the present invention;

FIG. 3 is a diagrammatic representation of a frame of data consistent with conventional communication systems;

FIG. 4 is a diagrammatic representation of transmission line channels and an optimized bundle consistent with an embodiment of the present invention;

FIG. 5 is a flowchart exemplary of a methodology for initializing the optimization interface(s) shown in FIG. 2;

FIG. 6 is a flowchart exemplary of a methodology for optimizing transmissions consistent with a methodology associated with the present invention;

FIG. 7 is a flowchart exemplary of a methodology for restoring transmissions consistent with a methodology associated with the present invention;

FIG. 8 is a diagrammatic representation of an optimized frame of data consistent with the present invention;

FIG. 9 is a diagrammatic representation of a data stream consistent with the present invention;

FIG. 10 is a functional block diagram of an optimization interface consistent with an embodiment of the present invention

FIG. 11 is a functional block diagram of a coding engine associated with the optimization interface of FIG. 10; and

FIG. 12 is a functional block diagram of a decoding engine associated with the optimization interface of FIG. 10.

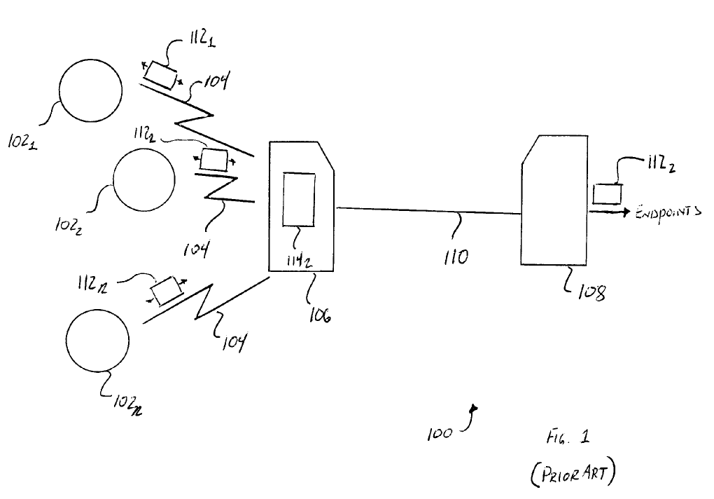

### DETAILED DESCRIPTION

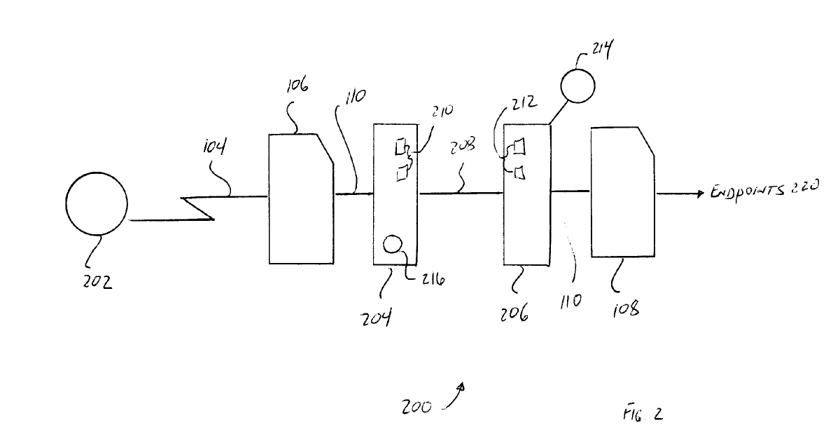

The present invention will be described with reference to FIGS. 2-12. While the present invention is described in relation to mobile communication systems transmitting, one of ordinary skill in the art will recognize on reading the disclosure that the present invention could be used in other data transmission systems using transmission protocols with portions of the data transmission being preprogrammed to particular values.

Referring now to FIG. 2, a functional block diagram of a bandwidth optimization system 200 is disclosed. For convenience, system 200 will be explained with reference to a single transmitting station 202 transmitting data. Transmitting station 202 is used generically to mean any subscriber device whether mobile or stationary, such as, for example, a remote server, a cellular telephone, a PDA, a portable computer, a desktop computer, a printer, or the like. However, the present invention will be explained with reference to a transmitting station 202 that is a mobile device and uses a wireless communication link 104 to BTS 106. An optimization interface 204 is shown connected to BTS 106 by a communication link 110, such as, for example, a T-1 line, but may be integrated into BTS 106 as desired. Optimization interface 204 may have channel specific state machines 210 (which will be explained further below) for the one or more channels being transmitted. Optimization interface 204 may have a buffer 216 or an external memory. Optimization interface 204 is connected to another optimization interface 206 by a communication link 208. Communication link 208 may be a conventional transmission line such as, for example, a T1 line, a T3 line, the E line equivalents or the like. Optimization interface 206 would have state machines 212 corresponding to state machines 210. Optimization interface 206 may have a buffer, similar to buffer 216, or external memory 214 as shown. Communication link 110 and 208 are not necessary the same type of transmission line. For example, link 110 may be conventional bus or ribbon cable, while communication link 208 may be a T3 transmission line. Optimization interface 206 is connected to BSC 108 by communication link 110. Optimization interface 206 may be integrated into BSC 108, but is shown as a separate unit for convenience. BSC 108 is connected to one or more local or remote endpoints 220 via any conventional protocols, such as, for example, using the Plain Old Telephone System, VoIP, Internet, LANs, WANs, WiFis, or the like. Endpoints 220 are generally known in the art and include processors, servers, PSTN telephones, cellular telephones, PDAs, support nodes, mobile switching centers, and the like. Endpoints 220, however, will not be described in detail as they are generally known in the industry.

Conventionally, data transmitted from mobile device 202 to endpoints 220 via BTS 106 and BSC 108 is formatted in a standard protocol, such as, for example, TRAU frames or the like. Standard protocols should be viewed broadly to include both standard's body sanctioned protocols, such as, for example, the 3GPP group specifications 8.6 and 8.61, including all updates, as well as proprietary protocols certain manufactures use. In other words, standard protocol means a knowable data format between The BTS and the BSC.

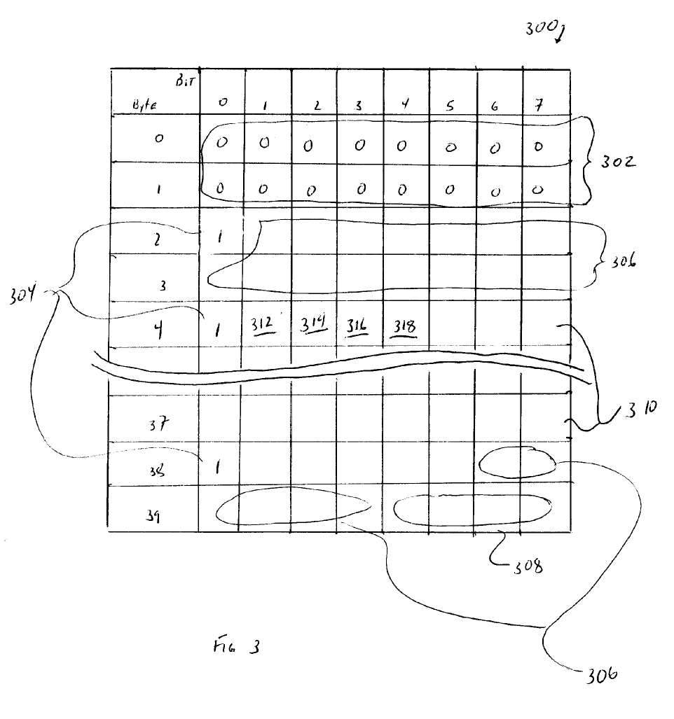

Referring now to FIG. 3, one possible conventional frame 300 is shown. Frame 300 is a representative illustration of frames of data and should not be considered limiting, but rather exemplary of a number of data communication protocols. Frame 300 corresponds to, for example, frame 1142 explained above. Frame 300 is shown as being 320 bits long, or 40 bytes (0-39) where each byte has 8 bits (0-7). Frame 300 can be broken into several groups parts. The first part includes leading bits 302. Leading bits 302 are predefined, in this case to “0”, and indicate a frame beginning. To ensure this same series of zeros in this case does not occur and mistakenly indicate the beginning of a new frame hard coded bits 304 exist. The hard coded bits 304 include the first bit following the leading bits 302 and every 16th bit thereafter. Frame 300 also includes several control bits 306 as well as time alignment bits 308. The remaining bits are data bits 310, or the payload.

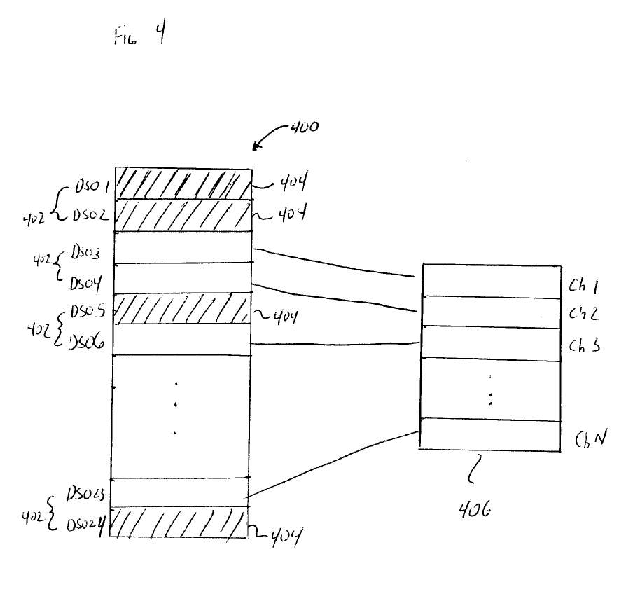

Communication between BTS 106 and BSC 108 typically occurs by transmitting data in a bit stream. While all the channels could transmit the data using the same frame configurations, they do not always use the same frame configurations although the bandwidth compression techniques described below can be used for multiple frame configurations. Referring to FIG. 4, a conventional T1 transmission line 400 is diagrammed. T1 transmission line 400 contains a number of channels 402, as shown by channels DS0 1 to DS0 24 in this example. As one of ordinary skill in the art would understand, T1 transmission line 400 and channels DS0 1-24 are representative of a typical T1 line. Other transmission lines and digital signal levels could be used and the above example is exemplary.

In cellular communication, transmission of a plurality of frames from BTS 106 to BSC 108 occurs 2 bits at a time. In other words, the data stream from BTS 106 to BSC 108 occurs by sending two bits of frame 300 for the first sub-channel associated with DS0 1, then two bits of the frame of data for the second sub-channel associated with DS0 1 through the last sub-channel associated with DS0 24, at which point the next two bits associated with the first sub-channel are transmitted. Thus, if portions of frames 300 associated with each sub-channel could be removed and reproduced, it would significantly increase the ability of existing connections between BTS 106 and BSC 108 to transmit data.

One potential means to reduce bandwidth is presented by U.S. patent application Ser. No. 10/633,260, publication number 2004/0077345, filed Aug. 1, 2003, titled METHODS AND APPARATUS FOR NETWORK SIGNAL AGGREGATION AND BANDWIDTH REDUCTION, incorporated herein by reference. The generic idea of the application is to remove information from each frame that does not need to be transmitted. In the '260 application; however, no workable solution is provided. In particular, the '260 patent discloses “regenerable information” may be eliminated form the transmission. By eliminating the regenerable information, the throughput and bandwidth of the transmission is reduced. Rather than identifying specifically what is regenerable information, the '260 application identifies regenerable information as including “data content in the message traffic 23 reproducible at a receiving side from information accessible at the receiving side, or that the receiving side backhaul gateway 40 can reproduce based on communications 26 formatted in the common protocol format of this invention.” However, the '260 application fails to identify what information is actually regenerable, what information is reproducible at a receiving side from information accessible at the receiving side, and what information can be reproduced based on the common protocol format. In fact, it has been found that the '260 application is in fact an unworkable solution because, for example, the frames of data cannot be reproduced using the methodologies and systems disclosed in the application.

Thus, while an interesting idea, the solution presented was unworkable. However, in evaluating the '260 application, it was discovered that frames of information could be compressed and transmitted. Referring again to frame 300, multiple bits of information can be removed from the transmission at BTS 106 and reinstated at BSC 108 thus reducing bandwidth. For example, leading bits 302 are known to be 16 bits of “0s.” Thus, it would be possible to remove the leading bits from the frame prior to transmission and reinstate the bits when the frame of data is reconstructed at BSC 108. Similarly, hard coded bits 304, as well as other protocol dependent or predefined bits, do not need to be transmitted along with payload 310. Control bits 306 may or may not be removed and reinserted depending on the bits. For example, control bits 306 provide, in part, “frame type” information. If the control bits over sequential frames indicate the frame remains the same as the previous frame, those control bits 306 may be removed and replaced in a header with an indication that the frame is the same as the previous frame. Further, time alignment bits 308 are knowable and may be removed and reinserted. The removed bits will be generically referred to a “protocol dependent bits,” “protocol predefined bits,” “protocol defined bits,” “knowable bits,” or the like.

Once the protocol dependent bits are identified, a frame template can be stored in, for example, memory 214. The frame template generally describes the positions of bits 302, 304, 306, and 308, as well as other bits, enumerated above. When data is transferred, the protocol dependent bits can be removed and a control header of information can be appended to the data actually transferred. At BSC 108, the data would be recovered by using information regarding the protocol dependent bits from memory 214 and the protocol dependent bits could be inserted into the data as required. Unlike the data identified by the '260 application, the present invention thus uses data available at the receiving side as well as protocol specific information to reduce the transmission size.

While all DS0 channels 1-24 (channels 402) are capable of compression, for various reasons, some OEMs elect to not allow compression of some DS0 channels. Thus, T1 transmission line 400 may contain DS0 channels unavailable for compression, referred to as unavailable channels 404. The channels may be unavailable for a number of reasons including without limitation, customer specifications, unavailable data format knowledge, or the like. Thus, those channels available for compression are gathered into a bundle 406 comprising the data or payload 310 of channels 1 to M, where M is the number of channels available for compression.

Notice, while shown as a channel to channel compression, the optimized bundle 406 of payload 310 virtually pools the channels. For example, channel DS0 6 may be available for optimization, but not connected to transmitting station 202. Under conventional transmission, because DS0 6 would be idle, the bandwidth on the T1 line associated with DS0 6 would be wasted. Making DS0 6 available as a optimization channel means a header is appended to indicate DS0 6 is idle such that the bandwidth previously reserved for DS0 6 can be used for other channels/sub-channels. As one of ordinary skill in the art would now recognize, idle, silent, or otherwise unused channels or sub-channels can be defined as protocol dependent bits. Moreover, corrupted data is a protocol dependent bit because, while not defined, the header can include information instructing whatever payload is sent should have been ignored, so generate “filler” data.

The DS0 channels available for optimization/compression can be manually programmed for each T1 transmission line 400 or can be automatically configured by examination of the data contained within the channel. The unavailable channels 404 would be appended to the bundle 406 of compressed channels and packaged for transmission of communication link 208 using conventional methods and protocols for transmission.

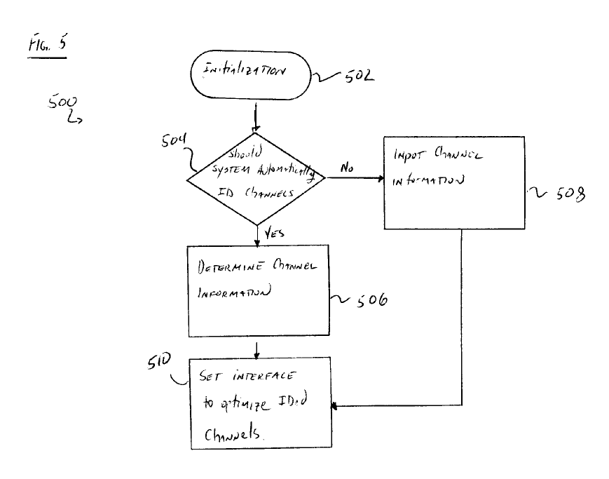

Compression of a T1 transmission line 400 to bundle 406 is further described with reference to FIGS. 5 and 6. FIG. 5 is a flowchart 500 illustrating an initialization procedure to identify channels available for optimization. The initialization procedure would typically be a system start up procedure, but could occur whenever desired. Typically, the initialization procedure would be operated at optimization interface 206, which is associated with BSC 108. Optimization interface 204 would receive channel information from optimization interface 206 as part of a master/slave relationship. However, optimization interface 204 could independently initialize and/or be the master. Generally, it is preferred to initialize the system at the BSC 108 side because BSC 108 may interact with multiple BTS 106s.

Referring specifically to FIG. 5, the system and compression machines are initialized, step 502. Once initialized, the optimization interface 206, or optimization interface 204, or some combination thereof, examines the transmission line configuration to determine whether it can and/or should automatically identify those channels available for optimization, step 504. If automatic identification of those channels is elected, the channel information is extracted, step 506. Channel information is used generically to mean whether the channel is available for optimization or not. If it cannot automatically identify those channels or automatic detection is not desired, the available channels can be manually input, step 508. Once identified, either automatically or manually, the interface is set to optimize identified channels, step 510.

Referring now to FIG. 6, a flowchart 600 illustrating one methodology for optimizing data consistent with the present invention is provided. Once the channel information is either extracted or input, the channel data is captured on a per-channel basis, step 602, and the captured channel is assigned to a state machine, step 604. Frame 300, for example, is reduced pursuant to optimization rules and payload 310 from frame 300 is packaged into an optimized frame, which will be further defined below, step 606. The optimized frame is packaged within bundle 406, step 6-8. And, bundle 406 is multiplexed and transmitted over the communication link 208 to BSC 108, 610.

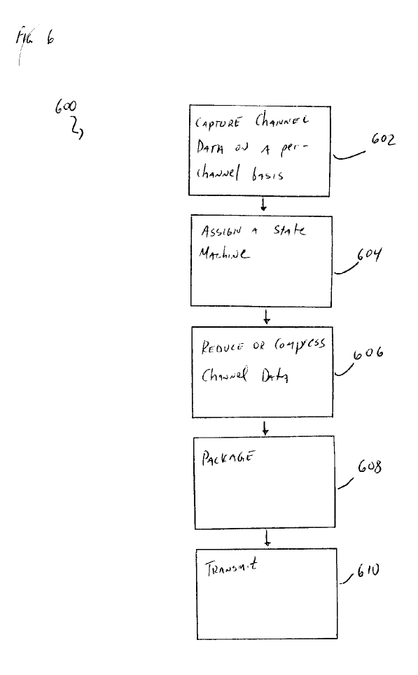

Referring now to FIG. 7, a flowchart 700 illustrating one methodology for reconstructing data consistent with the present invention is provided. First, the compressed data is captured, step 702. The optimized channels are assigned to state machines, step 704, and demultiplexed, step 706. The data is reconstructed or rebuilt according to the rebuilding rules, which will be further explained below, step 708. The data is time aligned, step 710. Steps 702 to step 710 are repeated for all transported data, step 712.

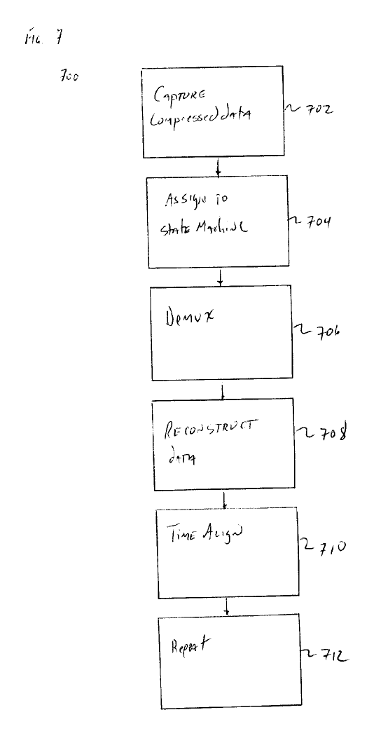

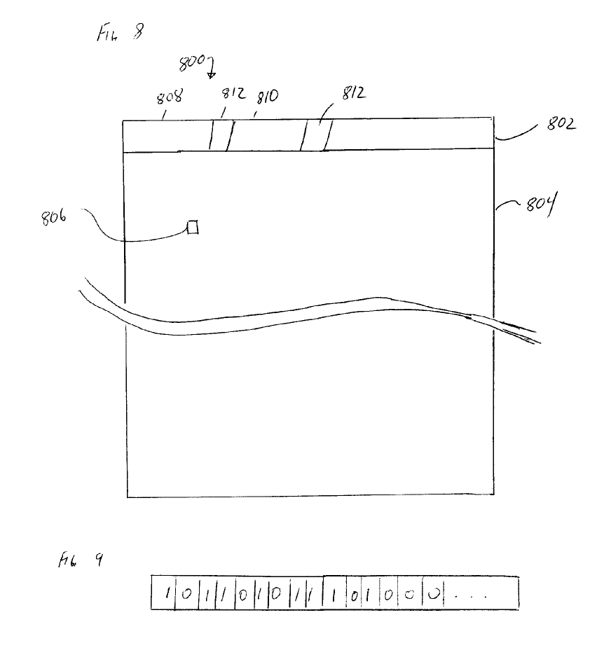

Referring now to FIG. 8, an optimized frame 800 is shown. Optimized frame 800 includes a control header 802 and a payload 804. Payload 804 comprises a compilation of bits 806 of payload 310 from a plurality of frames 300. Because optimized frame 800 contains payload 804 comprising payload 310 from a plurality of frames with protocol predefined bits removed, control header 802 needs to provide information to allow reconstructing the data. Thus, control header 802 indicates what type of frame is being sent, when a frame begins (optionally, when the frame ends could be sent for error detection, but when the frame ends is determinable by indicating the type of frame and the beginning of the frame), and the like. Control header data 802 will now be explained assuming at least one new frame 300 is being sent over communication link 208. Further assume, optimized frame 800 has a payload 804 that begins with the following bit sequence, 1 0 1 1 0 1 0 1 1 1 0 1 0 0 0 . . . (the bits are exemplary and of no particular consequence). FIG. 9 represents a bit stream 900 over communication link 208 for the bit sequence of optimized frame 800. As can be seen from bit stream 900, payload 804 does not provide any indication to the BSC 108 or optimization interface 206 that a new frame of data has begun. Thus, header 802 includes a first chunk 808 indicative of whether a new frame has started. A second chunk 810 of header 800 is indicative of the type of frame. The frame type may be an actual frame type indication or an indication that the frame type is the same as the previous frame. This allows optimization interface 206, for example, to reconstruct the original data using header information. For example, for bit sequence 1 0 1 1 0 1 0 1 1 1 0 1 0 0 0 . . . , control header 802 may contain information that instructs the following; 1. Bits 1 0 are data bits for a frame of data associated with DS0 1 sub-channel 1; 2. DS0 1 sub-channel 2 is in the beginning of a new frame, and has protocol dependent bits; 3. Bits 1 1 are data bits for a frame of data associated with DS0 1 sub-channel 3; 4. Bits 0 1 are data bits for a frame of data associated with DS0 1 sub-channel 4; 5. etc;

Theoretically, frames 300 could be rebuilt by retrieving from a memory 214 (which may be associated with the state machine, the interface, or separate as shown) a template of frame 300 inserting protocol predefined bits, such as, for the example shown above, frame 300 would have leading bits 302, hard coded bits 304, control bits 306, and time alignment bits 308 already inserted into the rebuilt frame 300′, which would be identical to frame 300 and will not be re-shown. But as one of ordinary skill in the art would recognize, the frames are not “rebuilt,” but rather the protocol dependent bits are inserted into the bit stream. To ensure data accuracy, error code data chunks 812 may be placed in header 802. Error codes may be a check sum error code or the like. While an end frame data chunk could be sent, it is believed sending channel bandwidth information as a bandwidth data chunk 808 works as well. Although the frame end is knowable based on the protocol and end frame or bandwidth information does not need to be sent. Additional information includes, for example, a frame update data chunk, a new frame type data chunk, a treat channel as idle data chunk, a data corruption chunk, or the like. Data corruption information could be particularly useful. For example, assume frame type information is corrupted in the transmission. The data is unrecognizable because the frame type is corrupted. Under the optimization protocol defined above, if the next frame is the “same,” the next frame data would also be corrupted because the control header would send an indication that the frame type is “the same” as the previously sent corrupted data. On an indication of corruption, an instruction could be provided requiring all information be resent even if it is the same as previous information sent.

As can be seen, although a significant number of bits can be removed from each frame 300 to decrease bandwidth, control header 802 causes a number of bits to be added to the transmission which increases bandwidth. Thus, the more information contained in header 802, the less efficient the optimization procedure.

As mentioned above, both the compression and decompression procedures require identifying channels and obtaining channel specific information. One option, as described by step 508 includes inputting information manually. The information input includes the starting location within, for example, the T1 channel, the type, and the bandwidth. The second option, as described by steps 504 and 506 includes automatic detection and extraction of channel information. Automatic detection can be accomplished by interface 206 using an auto-detection methodology and/or a raw detection methodology. As explained above, detection could occur at interface 204 or both interface 204 and 206.

Auto-detection requires the system to monitor known traffic channels and in so doing provision the remaining channels. Thus, interfaces 204, 206 need to negotiate between BTS 106 and BSC 108 in a deterministic manner. This may include mapping information of the primogenitor signaling channel, which would affix itself to a particular location/bandwidth within the transmission, such as a T1 transmission, so that a completely-uninitialized BTS would be able to bootstrap a channel map. Note, only one interface needs to auto-detect as the other interface could be a slave. Thus, if interface 206 auto-detected the channels, interface 204 could be a slave and receive mapping transmitted from the master interface 206 over a data link (HDLC, LAPD, or the like) running over communication link 208.

The raw-detection method does not require predefined knowledge of the transmission or the mapping assignments within the signaling data. Rather the signaling data is used to snoop the transmission line (such as a T1 line) for changes in patterns. Using pattern matching heuristics, the detection logic would attempt to lock on to expected patterns within the transmission and test whether those patterns are frames, such as, TRAU frames, or not.

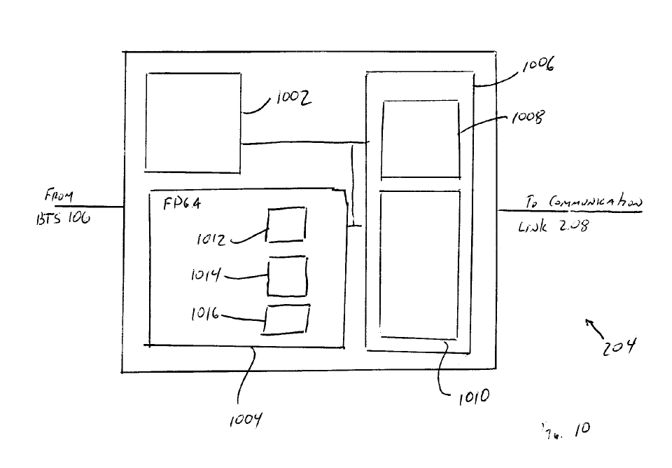

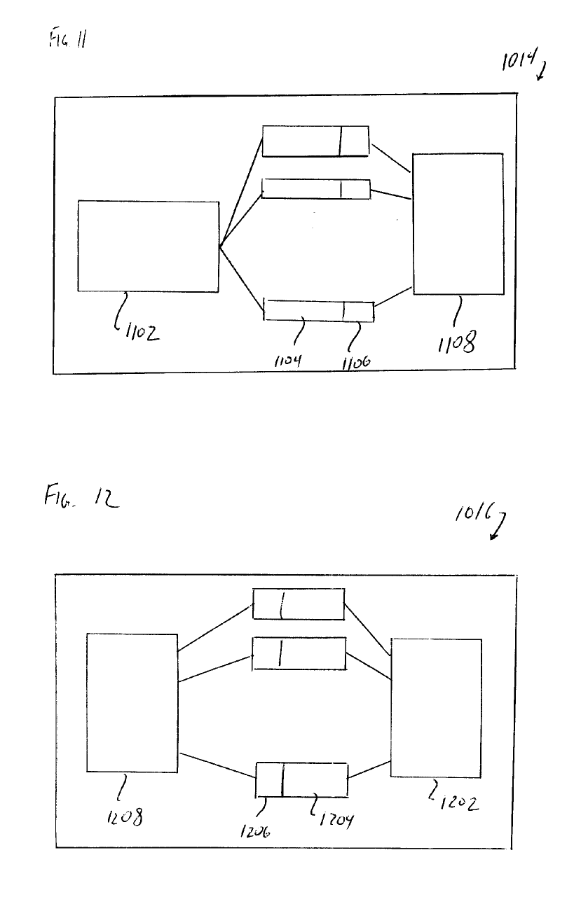

Referring now to FIG. 10, optimization interface 204 is explained in more detail. Optimization interface 206 is similar and the similarities will not be further explained. Optimization interface 204 comprises a framer 1002, programmable logic 1004, which is shown as a field programmable gate array (“FPGA”), a winpath 1006 including a core controller 1008 and a network processor 1010. While FIG. 10 depicts a system capable of coding and decoding, for example, TRAU frames, it is contemplated that state machines 210 and 212 will providing the optimization itself. For example, state machine 210 extracts the reconstructable data 302, 304, 306, and 308 while state machine 212 reconstructs the data by reinserting data 302, 304, 306, and 308. To function, state machines 210 and 212 must be synchronized to the beginning of new frames, which as mentioned above is provided by having state machine 210 compile header 800 and state machine 212 use header 800 when rebuilding frame 300. Programmable logic 1004 comprises channel ID 1012, coding engine 1014, and decoding engine 1016. Notice, if optimization interface 204 was a one-way interface, programmable logic 1004 would only require coding engine 1014 or decoding engine 1016. Coding engine 1014 and decoding engine 1016 are shown in more detail with respect to FIGS. 11 and 12. Referring now to FIG. 11, coding engine 1014 comprises a channel demultiplexer 1102, a plurality of compressors 1104 and associated buffers 1106, and an aggregator 1108. Demultiplexer 1102 separates the channels capable of being optimized and feeds each channel to a corresponding compressor 1104. Compressor 1104 removes the protocol defined data and sends the optimized data to aggregator 1108. Buffer 1106 provides limited memory cache to limit the time delay associated with the system as some of the data can be sent in advance and some buffered. Aggregator 1108 combines payloads 310 from a plurality of frames 300 into the optimized payload 804 and transmits the data over communication link 208. Referring now to FIG. 12, decoding engine 1016 will be explained with reference to optimization interface 206. Interface 206 receives the optimized transmission from communication link 208 and a segregator 1202 segregates the optimized transmission into optimized channel data. The optimized data is sent to a decompressor 1204 and time aligner 1206. Decompressor 1204 sychnronizes and rebuild the data, such as, for example, by inserting protocol dependent bits. The rebuilt data is sent to a multiplexer 1208 and transmitted to BSC 108 for conventional use and transmission to various endpoints 220.

As shown in FIG. 12, a time aligner 1206 is included in at least interface 204. Time aligner 1206 is necessary because the TRAU frame coming out of the decompressor must be aligned in time as per the BTS request. As one of ordinary skill in the art recognizes, the BTS uses, for example, bit C6-C11 of the TRAU control bits 306 to indicate to the BSC how to align the TRAU frame. This is done by padding the end of the previous TRAU frame with a knowable or certain number of 1s, the time alignment bits 308. The number of time alignment bits 308 is based on the control bit value 306.

While the invention has been particularly shown and described with reference to an embodiment thereof, it will be understood by those skilled in the art that various other changes in the form and details may be made without departing from the spirit and scope of the invention.

What is claimed is:

1. A method of optimizing data for transmission, the method comprising the steps of:
receiving a plurality of frames of data for transmission over a communication link;
for each of the plurality of frames, identifying whether the frame of data can be optimized;
if the frame can be optimized, the optimizing process further comprises the steps of:
identifying a frame type for the frame of data;
extracting a payload form the frame of data;
compiling a header associated with the optimized frame of data; and
generating an optimized frame of data;
aggregating a data stream comprising the optimized frame of data and any non-optimized frames of data;
appending the compiled header to the aggregated data stream; and
transmitting the aggregated data stream.

2. The method of claim 1, further comprising providing an error correction with the header.

3. The method of claim 1, further comprising providing error detection with the header.

4. The method of claim 1, wherein the extracting the payload step comprises removing protocol dependent bits from the frame of data.

5. The method of claim 1, wherein the compiling the header step comprises:
indicating when a new frame of data has begun;
when a new frame of data has begun, indicating the frame type.

6. The method of claim 5, wherein indicating of the frame type includes instructing an interface to use a previously indicated frame type.

7. The method of claim 1, further comprising the steps of:
initializing a state machine for each channel associated with the transmission.

8. The method of claim 1, further comprising the steps of:
obtaining channel information.

9. The method of claim 8, wherein the step of obtaining channel information comprises manually inputting channel information.

10. The method of claim 8, wherein the step of obtaining channel information comprises automatically extracting channel information.

11. The method of claim 4, wherein the protocol dependent bits comprises at least one of synchronization bits and control bits.

12. The method of claim 4, wherein the protocol dependent bits further comprise at least one of hard coded bits and time alignment bits.

13. The method of claim 4, wherein the protocol dependent bits further comprise leading bits.

14. The method of claim 1, wherein the step of aggregating the data stream effectively pools transmission line resources.

15. A method of reconstructing optimized data transmitted, the method comprising;
receiving a data stream comprising at least a header and a plurality of optimized data;
segregating the header and the optimized data into corresponding channels;
using the header to identify a frame template including protocol dependent bits;
generating a reconstructed frame;
populating the reconstructed frame with the protocol dependent bits;
inserting bits from the data stream into the reconstructed frame; and
outputting the reconstructed frame as an original data frame for transmission to at least one endpoint.

16. The method of claim 15, further comprising the step of error detection.

17. The method of claim 15, further comprising the step of error correction.

18. The method of claim 15, wherein the header identifies a new frame beginning, a frame type, and a frame bandwidth.

19. The method of claim 15, wherein the data stream transmits the optimized data in two bit increments.

20. The method of claim 15, wherein the data stream transmits the optimized data in four bit increments.

21. The method of claim 15, wherein the data stream transmits the optimized data in byte increments.

22. The method of claim 15, wherein the protocol dependent bits comprise at least one of synchronization bits and control bits.

23. The method of claim 15, further comprising the steps of:
obtaining channel information.

24. The method of claim 23, wherein the step of obtaining channel information comprises manually inputting channel information.

25. The method of claim 23, wherein the step of obtaining channel information comprises automatically extracting channel information.

26. The method of claim 15, further comprising the step of initializing a state machine for every optimized data channel.
